(19) United States
(12) Patent Application Publication
(10) Pub. No.: US 2012/0193283 A1
(43) Pub. Date: Aug. 2, 2012

(54) POLYPROPYLENE FILTER

(76) Inventor: Sidney LENZ, Cacador - SC (BR)

(21) Appl. No.: 13/018,708

(22) Filed: Feb. 1, 2011

(51) Int. Cl. B01D 39/16; B01D 29/35

(52) U.S. Cl. 210/497.2; 210/497.01

(57) ABSTRACT

A polypropylene filter for filtering liquids manufactured exclusively of polypropylene (PP) with fresh raw material, weighting between 40 grams and 45 grams resulting in TNT (fabric-like material), wherein there is a quadrilateral mono-block body (1) assembled from the union of a frontal face (9) with a posterior face (10), for all the lateral seams (3), and a bottom face (4), resulting in a container (5) with an inlet (6) between a frontal seam (7) and a posterior seam (8), which narrows from the inlet (6) to the bottom face (4), and the filter can be cleaned and reused, at least, three times.

### FIELD OF THE INVENTION

This present application refers to a new filter made, exclusively, of polypropylene (PP) wherein it is made out of fresh raw material, weighting between 40 grams and 45 grams, with no risk of contamination by impurity, resulting in a TNT C, also known as nonwoven (fabric-like material).

### BACKGROUND OF THE INVENTION

The use of several types of filters is common in households and in industries. In some regions the cloth filter is still used, and as time went by the disposable paper filter, which is a practical product, was developed. However, its disadvantages are the fact that it is disposable, and can be used only once, in addition to the fact that should it get wet, it can be disposed, and it cannot be stored for more than 5 years.

What is needed therefore is a new filter that can be used to filter teas, coffees, oils and other types of liquids and be cleaned and reused before its final disposal.

### SUMMARY OF THE INVENTION

The present invention seeks to provide a polypropylene filter for filtering liquids, wherein there is a quadrilateral mono-block body, exclusively manufactured in polypropylene (PP) with fresh raw material, TNT (fabric-like material). The filter is a polypropylene filter for filtering liquids having a quadrilateral mono-block body assembled from a union of a frontal face with a posterior face, along a lateral seams, with a bottom face, resulting in a container with an inlet between a frontal seam and a posterior seam, which narrows from the inlet to the bottom face.

Another important factor is its lateral sealing process, via ultrasound auto fusion, that even after the process does not alter the flavor and does not contaminate the liquids after the filtering, maintaining the original indispensable characteristics.

The flow of the liquid, with this new TNT filter, tops the flow of the filters available in the market, and the contact with other utensils does not yield the absorption of odors, regardless of color.

The exclusively polypropylene (PP) or (TNT) filter (fabric-like material), as it is known, after use, even with high-temperature water, can be cleaned and dried and it is ready for reuse, without losing the characteristics of a new filter.

The filter of the present application has a very quick drying, and due to its weight, between 40 grams and 45 grams, it yields a better filtering of the liquid through the fabric, without the transfer of powder or remaining residues.

Another advantage of the present filter and material is the shelf life, which might reach 10 years, while others' shelf life is of 5 years or less.

### BRIEF DESCRIPTION OF THE DRAWINGS

FIG. 1 is an orthogonal frontal view of the filter, the other face being equal.

FIG. 2 is a top and frontal view of the filter, in perspective.

FIG. 3 is a top and posterior view of the filter, in perspective.

FIG. 4 is a lower and frontal view of the filter, in perspective.

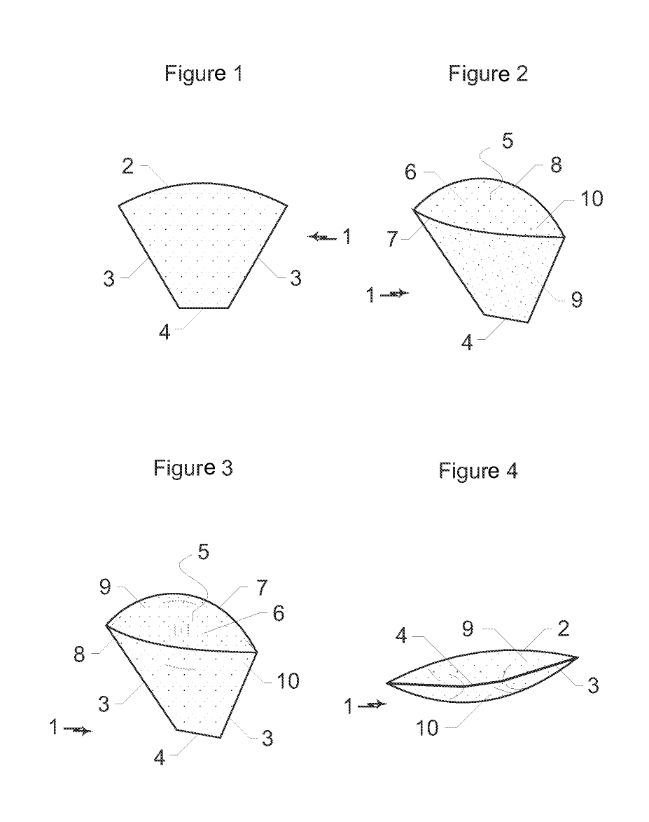

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

The present invention includes a quadrilateral mono-block body (1) exclusively polypropylene (PP) manufactured, with fresh raw material, with no risk of contamination by impurity, resulting into a TNT (fabric-like material), known also as Nonwoven (fabric-like material) weighting between 40 grams and 45 grams. The quadrilateral mono-block body (1) is assembled from the union of the frontal face (9) with the posterior face (10), via an auto-fusion process in ultrasound, which warms the fabric threads, allowing the homogeneous fusion of the faces, along the lateral extremities/seams (3), and the bottom face (4), resulting in an container (5) with inlet (6) between the frontal seam (7) and the posterior seam (8), which narrows from the inlet (6) to the bottom face (4).

Therefore, the present application is a new filter, exclusively polypropylene (PP) manufactured, resulting into TNT (fabric-like material), lined as evidenced by the research conducted, accompanied by the annexed Figures, which acted as aids, and which is different from the existing and similar models, generally known in the market.

1. A polypropylene filter for filtering liquids having a quadrilateral mono-block body, exclusively manufactured in polypropylene (PP) with fresh raw material, TNT (fabric-like material).

2. A polypropylene filter for filtering liquids having a quadrilateral mono-block body assembled from a union of a frontal face with a posterior face, along a lateral seams, with a bottom face, resulting in a container with an inlet between a frontal seam and a posterior seam, which narrows from the inlet to the bottom face.

3. The polypropylene filter according to claim 2, wherein the union of the frontal face with the posterior face is performed via an auto-fusion process in ultrasound.

4. The polypropylene filter according to claim 1, wherein the quadrilateral mono-block body weights between 40 grams and 45 grams.

5. The polypropylene filter according to claim 2, wherein the quadrilateral mono-block body weights between 40 grams and 45 grams.

6. The polypropylene filter according to claim 1, wherein the quadrilateral mono-block body can be reused after cleaning.

7. The polypropylene filter according to claim 2, wherein the quadrilateral mono-block body can be reused after cleaning.
